(19) United States
(12) Patent Application Publication
(10) Pub. No.: US 2025/0272879 A1
(43) Pub. Date: Aug. 28, 2025

(54) TRICHROMATIC PHOTOGRAPH-COMPUTED SPECTROMETRY

(71) Applicant: Purdue Research Foundation, West Lafayette, IN (US)

(72) Inventors: Young L. Kim, West Lafayette, IN (US); Semin Kweon, West Lafayette, IN (US); Sang Mok Park, West Lafayette, IN (US); Jungwoo Leem, West Lafayette, IN (US)

(73) Assignee: Purdue Research Foundation, West Lafayette, IN (US)

(21) Appl. No.: 19/052,066

(22) Filed: Feb. 12, 2025

Related U.S. Application Data
(60) Provisional application No. 63/557,566, filed on Feb. 25, 2024.

(51) Int. Cl. G06T 7/90; G06V 10/56

(52) U.S. Cl. CPC G06T 7/90; G06V 10/56; G06T 2207/10024; G06T 2207/20081

(57) ABSTRACT

A color chart with a plurality of reference color patches is designed and produced to exhibit low spectral correlation among the patches, ensuring that each reference color patch is distinct in its spectral properties. Each patch is generated by selecting primary colors that differ by a predetermined change-step, minimizing spectral redundancy across the patches. The pairwise spectral correlation coefficients of all patches collectively yield a global correlation coefficient below a defined threshold. Utilizing this color chart, a method is introduced for extracting spectral information from a sample captured using a multi-chromatic imaging device, where the color chart is placed near the sample. The process involves obtaining spectral responses of the multi-chromatic imaging device and capturing an image of the sample under arbitrary ambient light illumination. From the image, the spectral intensity of the ambient light is first determined, and then the sample's spectral information is extracted.

### CROSS-REFERENCE TO RELATED APPLICATIONS

The present non-provisional patent application is related to and claims the priority benefit of U.S. Provisional Patent Application Ser. 63/557,566, filed Feb. 25, 2024, the contents of which are hereby incorporated by reference in their entirety into the present disclosure.

### STATEMENT REGARDING GOVERNMENT FUNDING

This invention was made with government support under R01EB033788 awarded by the National Institutes of Health. The government has certain rights in the invention.

### TECHNICAL FIELD

The present disclosure generally relates to spectrometry, and in particular to computing spectral information from a trichromatic photograph of a sample.

### BACKGROUND

This section introduces aspects that may help facilitate a better understanding of the disclosure. Accordingly, these statements are to be read in this light and are not to be understood as admissions about what is or is not prior art.

Optical spectrometers and hyperspectral imagers with high spectral resolutions provide extensive molecular, biological, and physical information in both stationary and dynamic samples. A spectrometer measures the intensity at each wavelength after separating incoming light by its wavelength. A hyperspectral imager further extends spectral measurements into spatial coordinates, generating a 3D hyperspectral image dataset (generally known as a hypercube). Their typical applications include, but are not limited to, biology, medicine, environmental science, astronomy, geology, agriculture, defense, and security. To overcome the limitations of bulky instruments and slow data acquisition, the miniaturization of spectrometers and hyperspectral imagers is an active area of research.

Recent advances in hardware miniaturization leverage the nanofabrication of dispersive elements and filters, the integration of interferometer and microelectromechanical components, and the development of advanced reconstruction algorithms. In addition, powerful machine learning approaches have also rejuvenated this classically hardware-driven field.

The integration of spectrometers with smartphones has received considerable interest due to vast potential applications across various consumer and medical domains. The development of smartphone spectrometer hardware ranges from simple do-it-yourself methods using blank CDs or DVDs to the implementation of multispectral image sensors with advanced CMOS technologies. It should be noted that snapshot hyperspectral imaging poses additional technical challenges. Oftentimes, the need for additional accessories and bulky components, which must be attached to the smartphone, leads to consumer skepticism about the practicality and adaptability. Efforts have been made to embed a spectrometer with a compact form factor directly into smartphones, turning them into onboard spectrometers. Nevertheless, the absence of a successful market product is largely attributed to technical and financial challenges. Furthermore, computational spectrometers, relying on advanced spectral reconstruction algorithms, still face practical limitations due to the sophisticated hardware requirements associated with nanofabricated filters and detectors.

It is well known that photography is more than mere imagery; a photograph contains a wealth of spectral information. A conventional trichromatic camera (e.g., smartphone camera) with a 10-bit color depth format in the red, green, and blue (RGB) channels can capture more than 1 billion different colors (2¹⁰×2¹⁰×2¹⁰=1.07 billion). Recent studies show that a spectrum with a high spectral resolution can be reconstructed from RGB values or a few readings (also known as spectral reconstruction, spectral super-resolution, or spectral learning), using compressive (or compressed) sensing, statistical learning, and deep learning. However, these methods heavily rely on large training data or application-specific pretrained learning algorithms, which are often subject to overfitting. Consequently, an arbitrary spectrum of a sample of interest cannot be computed in a manner similar to that of a spectrometer or hyperspectral imager, discussed above.

Therefore, there is an unmet need for a novel approach that can use an acquired photograph of a sample with a trichromatic imaging device to compute spectral information from said photograph.

### SUMMARY

A color chart having a plurality of reference color patches with low spectral correlation is disclosed. The color chart includes a plurality of reference color patches, each reference color patch of the plurality of reference color patches having at least one primary color chosen from a plurality of primary colors different by a predetermined change-step as compared to all other reference color patches in the plurality of reference color patches. Pairwise spectral correlation coefficients of all pairs of the plurality of reference color patches result in a computed global correlation coefficient which is less than a predetermined threshold.

A method of extracting spectral information of a sample from a multi-chromatic photograph of the sample is also disclosed. The method includes obtaining a printed color chart having a plurality of reference color patches where each reference color patch having an associated spectral information with a low spectral correlation to any other reference color patches of the plurality of reference color patches. The method further includes obtaining spectral responses of a multi-chromatic imaging device. Additionally, the method includes placing a sample near the printed color chart, capturing an image of the sample and the printed color chart by the multi-chromatic imaging device under an arbitrary ambient light, extracting spectral intensity of the arbitrary ambient light, and extracting spectral information of the sample from the captured image.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1A is a partial schematic of trichromatic printed color patches of a color chart.

FIG. 1B provides corresponding spectra for each color patch of FIG. 1A.

FIG. 1C represents the Commission on Illumination (CIE) (1931) XYZ standard color-matching functions, which are used to define the tristimulus values of a color using three primary colors: X, Y, and Z.

FIG. 1D is a plot of chromaticity-y vs. chromaticity-x, representing Specifications for Web Offset Publications (SWOP) for 729 color patches of the present disclosure.

FIG. 1E is a partial trichromatic printed color chart with a U.S. quarter in one corner for size perspective.

FIG. 2 is a schematic showing ambient light with known spectral intensity applied to a translucent sample positioned between a trichromatic imaging device and a trichromatic printed color chart. Alternatively, and not shown, an opaque sample may be juxtaposed next to the trichromatic printed color chart.

FIG. 3a is a flowchart representing the method steps of the present disclosure.

FIG. 3b is an example of a computer system that can carry out processing steps of the present disclosure.

FIG. 4 is a spectrum of a Xenon calibration lamp measured using a scientific spectrometer as well as recovered by a photograph-computed spectrometry (PCS) using an onboard smartphone camera.

FIG. 5A is a ring-shape LED illuminating at a temperature set at 3000 K and spectral color chart (number of reference colors=729) under the corresponding illumination.

FIG. 5B shows the ring-shape LED of FIG. 5A illuminated at 4000 K and further provides the corresponding trichromatic printed color chart as well as an intensity vs. wavelength in nm graph.

FIG. 5C shows the ring-shape LED of FIG. 5A illuminated at 5000 K and further provides the corresponding trichromatic printed color chart as well as an intensity vs. wavelength in nm graph.

FIG. 5D shows the ring-shape LED of FIG. 5A illuminated at 5800 K and further provides the corresponding trichromatic printed color chart as well as an intensity vs. wavelength in nm graph.

FIG. 5E shows a rod-shape fluorescent tube light along with the corresponding trichromatic printed color chart as well as an intensity vs. wavelength in nm graph.

FIG. 5F is a representative photograph of four different food coloring solution samples: Red #40, Yellow #6, Green #1, and Blue #1 is shown.

FIGS. 5G, 5H, 5I, and 5J are the measured and recovered absorption spectra for food coloring Red #40 (FIG. 5G), Yellow #6 (FIG. 5H), Green #1 (FIG. 5I), and Blue #1 (FIG. 5J) of FIG. 5F.

FIG. 5K is a representative photograph of protein solution samples: chlorophyll-b and β-carotene. The measured and recovered absorption spectra are shown in

FIGS. 5L, and 5M are the measured and recovered absorption spectra for chlorophyll-b (FIG. 5L) and β-carotene (FIG. 5M) of FIG. 5K.

FIG. 5N is a representative photograph of high-value alcoholic spirits of two different blends.

FIGS. 5O and 5P are the measured and recovered transmission spectra of one blend and of another blend of FIG. 5N.

FIG. 5Q is a comparison of the recovered transmission spectra of the two blends shown in FIG. 5N, differentiating short wavelength range.

### DETAILED DESCRIPTION

For the purposes of promoting an understanding of the principles in the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is disclosed herein that can use an acquired photograph of a sample with a trichromatic imaging device to compute spectral information from said photograph. A photograph of a specialized color chart can be used to decode high-resolution spectral data from either a light source or a sample, because the RGB values of the chart's reference colors are altered accordingly. In other words, according to one embodiment, a translucent sample of interest or ambient light modulate the colors of the specialized color chart (referred to herein as the spectral color chart). The spectrum of the sample can be solved by various optimization methods. Towards this end, we introduce an approach referred to herein as photograph-computed spectrometry (PCS) that enables the extraction of high-resolution spectral data from an arbitrary sample of interest using a photograph obtained from a trichromatic imaging device, e.g., a smartphone. PCS employs a specially designed color reference chart (hereafter referred to as the spectral color chart) to decode high-resolution spectral data from i) an ambient environment, and ii) a specific sample. The process involves taking photograph of the spectral color chart alone and with the sample in both cases the RGB values of the chart's reference colors are modulated due to the ambient light condition or the sample. This spectral color chart can be positioned in juxtaposed behind a translucent sample of interest or juxtaposed next to an opaque sample of interest. In both cases, hyperspectral imaging becomes possible with a snapshot photograph utilizing a trichromatic imaging device (e.g., a smartphone), enabling the recovery of a hypercube (hyperspectral image dataset) of the sample. This approach eliminates the need for a more complicated hyperspectral imaging system.

First, the generation of the spectral color chart comprising a number of color patches is described. When generating a spectral color chart, it is important to achieve uncorrelated color patches when considering spectral information. As an initial matter, a number for how many color patches are presented in the spectral color chart. In the present disclosure, 729 color patches were chosen in the spectral color chart. However, it should be understood that a smaller number of color patches or a larger number of color patches can be utilized according to the present disclosure, and thus no limitation should be attached to said number of color patches. In transition from each color patch to the next, three primary colors are varied by a predetermined percentage, identified herein as the color-change step. For example, each color patch is advanced to the next color patch by modifying one of the primary colors by the color-change step of about 12.5%. After the spectral color chart has been constructed and analyzed, as discussed below, a correlation coefficient is calculated to determine how the color patches are correlated. If the correlation coefficient is above a predetermined threshold, indicating excessive correlation, the process spectral color chart generation process returns to choosing a different color-change step, either based on the value of the correlation coefficient or based on a predetermined set of color-change step values.

Thus, as a subsequent step color patches are chosen based on the first predetermined color-change step of 12.5%. The three primary colors are first chosen, e.g., cyan, magenta, and yellow, but other primary colors can also be implemented. The first color patch of the 729 color patches is represented by all said primary colors having 0%. The next color patch is presented by 12.5% in cyan and 0% for magenta and yellow. The next color patch is presented by 25% in cyan and 0% for magenta and yellow. The next few color patches are presented by 12.5% increase in cyan while maintaining magenta and yellow at 0% until obtaining 100% cyan. Next color patch is presented by 0% cyan but 12.5% magenta and 0% yellow. The next few color patches are presented by 12.5% increase in cyan while maintaining magenta at 12.5% and yellow at 0% until obtaining 100% cyan. Next color patch is presented by 0% cyan but 25% magenta and 0% yellow. The next few color patches are presented by 12.5% increase in cyan while maintaining magenta at 25% and yellow at 0% until obtaining 100% cyan. This process is repeated until magenta is selected at 100% while cyan is advanced from 0% to 100%. Next, the process is repeated for an increase from 0% to 12.5% for yellow. The process below provides a simple pseudocode for the progression of the colors.

```
For p=0,100/(color-change step)
  For q=0,100/(color-change step)
    For r=0,100/(color-change step)
    n=1
    color patchₙ (primary color₁(r*color-change step), primary
    color₂(q*color-
    change step), primary color₃(p*color-change step))
    n=n+1
    next r
  nextq
next p
```

wherein, the primary colorₘ where m=1, 2, and 3 represent three primary colors.

In the pseudocode provided above, for the color-change step of 12.5%, 729 (9*9*9) color patches are generated for three primary colors (e.g., cyan, magenta, and yellow), each with only one color-change step variation as compared to the previous color patch.

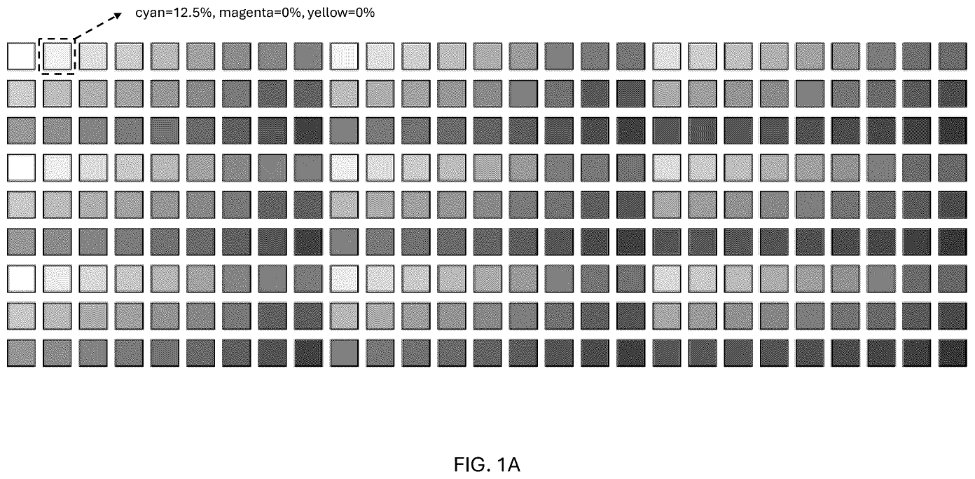

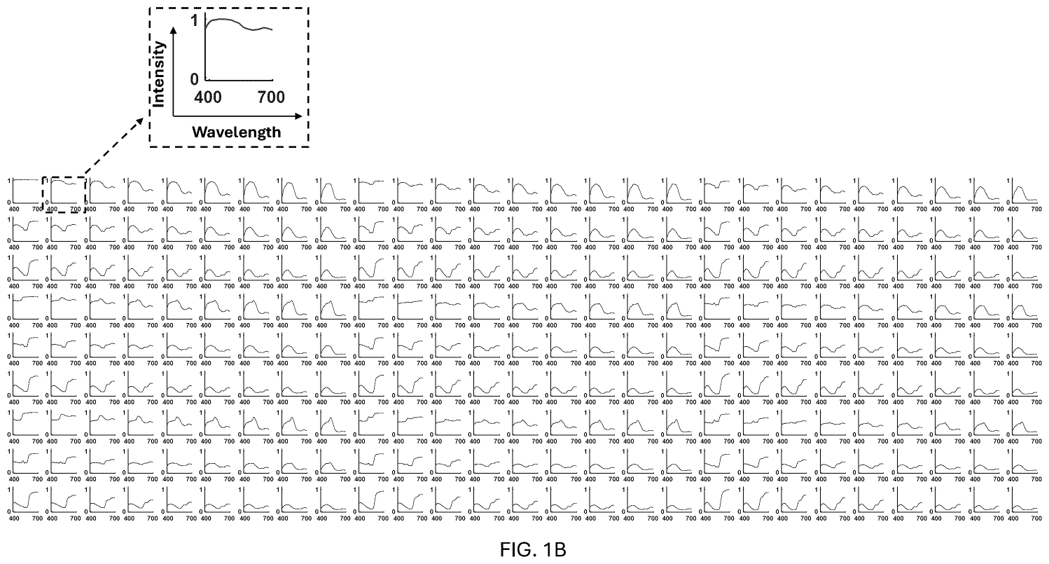

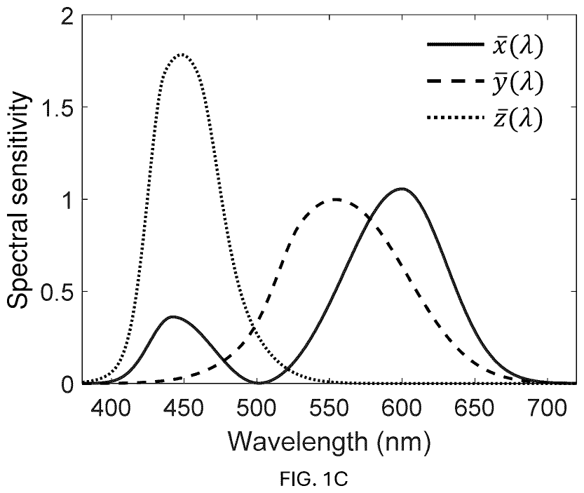

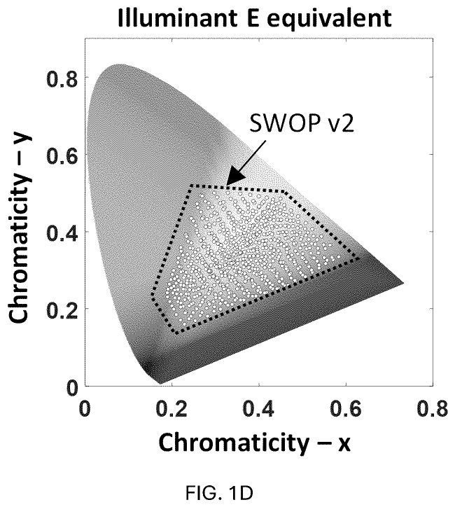

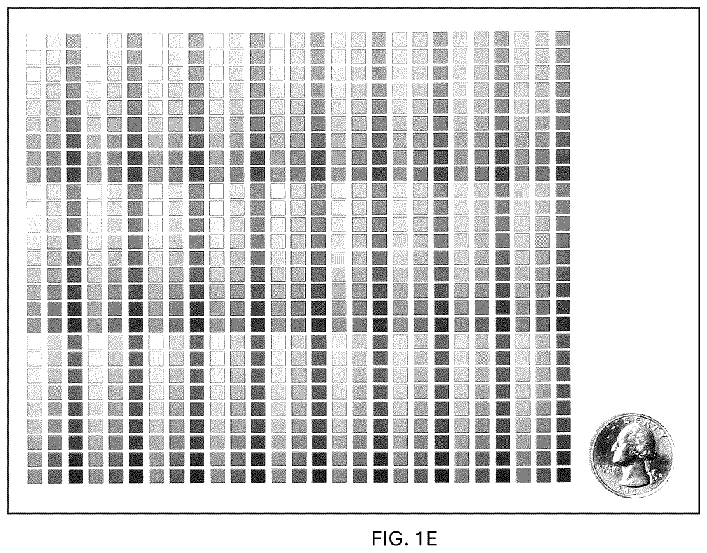

After the spectral color chart is generated, the chart is printed using a trichromatic color printer. The trichromatic printed color chart is next analyzed by spectrometer to obtain spectral information of each color patch. Reference is made to FIG. 1A which is a partial schematic of trichromatic printed color patches and to FIG. 1B which provides a corresponding spectrum for each color patch of FIG. 1A. In FIG. 1A, the second color patch is shown in the window with the specified values for the exemplary three primary colors; and in FIG. 1B the second spectrum corresponding to said color patch is shown in the window for improved clarity. The spectral information in each such spectrum in FIG. 1B is normalized for between a first and second wavelength (e.g., 380 to 720 nm). The spectral information is ascertained by using a spectrometer, and a reflectance standard as is known by a person having ordinary skill in the art. Once the spectral information are known for each color patch, corresponding International Commission on Illumination (CIE) values in XYZ space are calculated. This process involved obtaining the CIE XYZ values for each color using the CIE XYZ color matching functions x̅, y̅, and z̅:

X=∫F(λ)x̅(λ)dλ,

Y=∫F(λ)y̅(λ)dλ, and

Z=∫F(λ)z̅(λ)dλ,

where F denotes the spectral intensity of reference colors in the spectral color chart and λ denotes the wavelength of light. From the CIE XYZ values, the CIE xy chromaticity values can be calculated:

$$x = X / ( X + Y + Z ) , and$$

$$y = Y / ( X + Y + Z ) .$$

FIG. 1C represents the CIE (1931) XYZ standard color-matching functions, which are used to define the tristimulus values of a color using three primary colors: X, Y, and Z. This color space serves as the foundation for many other color spaces and models. According to the present disclosure, these functions are applied to the spectrum of the color chart, thus allowing to obtain the CIE XYZ values. From these values, we can then compute the chromaticity coordinates (x, y).

An example of CIE xy chromaticity values for the trichromatic printed color chart is shown in FIG. 1D which is plot of chromaticity-y vs. chromaticity-x, representing Specifications for Web Offset Publications (SWOP) for all 729 color patches. A partial trichromatic printed color chart is shown in FIG. 1E with a U.S. quarter in one corner for size perspective.

With CIE xy chromaticity values known, next a pairwise spectral correlation coefficient for all the 729 spectra of the trichromatic printed color chart is calculated. If the global total correlation coefficient is less than a predetermined value, e.g., 0.5, then the spectral color chart is viewed as acceptable. If, however, the global total correlation coefficient is not less than the predetermined value, then the method of the present disclosure returns back to resetting the color-change step and repeat the steps starting with generating a new spectral color chart by varying the primary colors by a new color-change step. The new color-change step is either selected from a predetermined look-up table, or based on the calculated global total correlation coefficient.

A different number of the reference colors can be used if the number is at least three times greater than the number of wavelengths. For example, the recovery performance remains reliable when 327 reference colors or more are used, ensuring that the number of known colors (327×3) is at least three times greater than the number of wavelengths with an interval of 1 nm.

Once a satisfactory spectral color chart has been generated, the finalized spectral color chart is then used to determine response of the trichromatic imaging device, e.g., a smartphone. To do so, first a photograph is obtained from the trichromatic printed color chart by the trichromatic imaging device under a known ambient condition (i.e., the spectrum of the ambient condition are known). The captured image is then analyzed to obtain trichromatic values (e.g., RGB values) of each color patch, resulting in, e.g., 729 sets of RGB values. The step of obtaining trichromatic values can be accomplished by a number of commercially available tools, e.g., ADOBE PHOTOSHOP®. Once the trichromatic values have been obtained for all color patches in the trichromatic printed color chart, a model is constructed based on:

$${I}_{i , k} = {\int }_{{λ}_{min}}^{{λ}_{max}} {F}_{i} ( λ ) {S}_{k} ( λ ) Q ( λ ) d λ ,$$

where, I_{i,k} is intensity in the trichromatic channels, e.g., RGB channels,
k refers to each channel for the trichromatic channels, e.g., k=1, 2, and 3 for, e.g., R, G, and B, respectively,
i represents the reference color patch, e.g., i=1, 2, . . . , 729,
F represents a spectral intensity as a function of wavelength (λ) of the i^{th} reference color patch,
S_{K} represents the trichromatic spectral response of the trichromatic imaging device also known as the spectral sensitivity) functions of the trichromatic channels, e.g., RGB channels, of the trichromatic imaging device, expressed as S_{R}, S_{G}, and S_{B} for, e.g., RGB channels—which is an unknown to be solved, and
Q is the illumination light spectrum as a function of λ. In the above equation, λₘᵢₙ and λₘₐₓ denote the wavelength range in the visible range (380-720 nm). Initially, the above equation is made into a discrete form:

I_{i,k}=Σₗ₌₁^{m}Fᵢ[l]Sₖ[l]Q[l]

The above formula is determined for each of the trichromatic channels for which S_{K} is solved for the respective trichromatic channel. The difference between λₘᵢₙ and λₘₐₓ is 341. Thus, m is 341. That between 380 nm and 720 nm at a 1 nm step, there are 341 distinct values (i.e., 380 nm, 381 nm, . . . 720 nm). Thus F can be represented as a matrix of 729×341 elements, Q as a matrix of 1×341 elements, and S_{K} as a matrix of 341×1. Thus, the above equation can be rewritten for RGB trichromatic channels as:

$${I}_{R 729 \times 1} = {F}_{729 \times 341} ⊙ {Q}_{1 \times 341} \times {S}_{R 341 \times 1} ,$$

$${I}_{G 729 \times 1} = {F}_{729 \times 341} ⊙ {Q}_{1 \times 341} \times {S}_{G 341 \times 1} ,$$

I_{B 729×1}=F_{729×341}⊙Q_{1×341} [symbol] S_{B 341×1}, where ⊙ represents element-by-element multiplication (e.g., Hadamard product) and [symbol] represents regular matrix operation. An example of the element-by-element multiplication is provided below:
Suppose A is a matrix of size 4×3 and b is a matrix of size 1×3. The element-by-element multiplication is shown below:

$$A = [ \begin{matrix}3 & 5 & 1 \\ 1 & 2 & 1 \\ 5 & 3 & 1 \\ 2 & 5 & 4\end{matrix} ] ,$$

$$b = [ \begin{matrix}4 & 1 & 2\end{matrix} ] ,$$

$$A ⊙ b = [ \begin{matrix}12 & 5 & 2 \\ 4 & 2 & 2 \\ 20 & 3 & 2 \\ 8 & 5 & 8\end{matrix} ] ,$$

thus an example of element-by-element multiplication for F_{729×341} and Q_{1×341} results in a matrix of size 729×341. This size is compatible with the S_{k 341×1} matrix when carrying out a regular matrix multiplication resulting in, e.g., I_{R 729×1}.

As indicated above, the S_{R} matrix represents the unknown quantity. Thus by determining the inverse of F_{729×341}⊙Q_{1×341}, having the size 729×341, and applying a regular matrix multiplication to each trichromatic intensity matrix, e.g., I_{R 729×1}, the Sₖ matrix for each trichromatic channel can be solved. Since F_{729×341}⊙Q_{1×341} is a non-square matrix, an optimization method known to a person having ordinary skill in the art, can be applied to determine inverse of said matrix.

Once the spectral response of the imaging device is known (i.e., once we have determined the S_{K} for each of the trichromatic channels), an ambient light with unknown spectral intensity is applied with a new photograph obtained from the trichromatic printed color chart. The same equation as above is presented again:

$${I}_{i , k} = {\int }_{{λ}_{min}}^{{λ}_{max}} {F}_{i} ( λ ) {S}_{k} ( λ ) Q ( λ ) d λ$$

however, this time Q(λ) is the unknown quantity. Q is determined in a similar fashion as above:

$$Q = {( F S )}^{- 1} I ,$$

whereas before I_{i,k} is intensity in the trichromatic channels, e.g., RGB channels,
k refers to each channel for the trichromatic channels, e.g., k=1, 2, and 3 for, e.g., R, G, and B, respectively,
i represents the reference color patch, e.g., i=1, 2, . . . ,729,
F represents a spectral intensity as a function of wavelength (λ) of the i^{th} reference color patch,
S_{K} represents the trichromatic spectral response of the trichromatic imaging device also known as the spectral sensitivity) functions of the trichromatic channels, e.g., RGB channels, of the trichromatic imaging device, expressed as S_{R}, S_{G}, and S_{B} for, e.g., RGB channels—which is an unknown to be solved, and
Q is the illumination light spectrum as a function of λ. As before, the above equation can be discretized as provided below:

I_{i,k}=Σₗ₌₁^{m}Fᵢ[l]Sₖ[l]Q[l]

As discussed above, I_{i,k} can be ascertained using commercially available software, e.g., ADOBE PHOTOSHOP®, for each color patch resulting in three matrices one for each of the trichromatic channels, e.g., I_{R}, I_{B}, and I_{G}, each having a size of 729×1, as provided below:

$${I}_{R 729 \times 1} = {F}_{729 \times 341} ⊙ {S}_{R 1 \times 341} \times {Q}_{341 \times 1} , {I}_{G 729 \times 1} = {F}_{729 \times 341} ⊙ {S}_{G 1 \times 341} \times {Q}_{341 \times 1} ,$$

I_{B 729×1}=F_{729×341}⊙S_{B 1×341} [symbol] Q_{341×1}, whereas before ⊙ represents element-by-element multiplication (e.g., Hadamard product) and [symbol] represents regular matrix operation. For simplicity, the three I_{R}, I_{B}, and I_{G} matrices can be combined into a single matrix having a size of 2187×1 while the ⊙ element-by-element multiplication of F and Sₖ matrices are combined into a single matrix of size 2187×341, while matrix Q remains as 341×1:

$${I}_{2187 \times 1} = {( F ⊙ {S}_{k} )}_{2187 \times 341} \times {Q}_{341 \times 1} .$$

As before, using an optimization method, known to a person having ordinary skill in the art, can be applied to determine the inverse of the matrix(F⊙Sₖ)_{2187×341} to determine the spectral intensity of the ambient light.

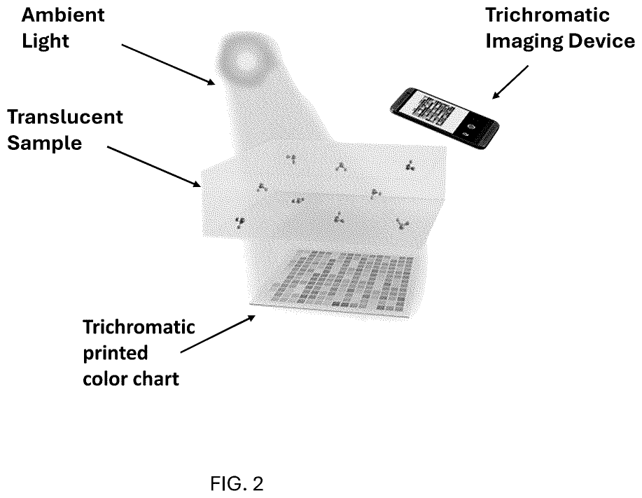

Once the ambient light spectral intensity is known, the same ambient light can be applied to i) a translucent sample positioned between the trichromatic imaging device and the trichromatic printed color chart, as shown in FIG. 2, or ii) an opaque sample juxtaposed next to the trichromatic printed color chart. A similar procedure is followed as described above. First, a new system model is established based on:

$${I}_{i , k} = {\int }_{{λ}_{min}}^{{λ}_{max}} {F}_{i} ( λ ) {S}_{k} ( λ ) Q ( λ ) T ( λ ) d λ$$

where T(λ) represents the transmission intensity of the sample. In this equation, all components are known (i.e., the spectral intensity of the ambient light from above, the spectral response of the trichromatic imaging device, as well as trichromatic intensity of the trichromatic printed color chart) except for T(λ). To solve for T(λ), first this equation is discretized as provided below:
I_{i,k}=Σₗ₌₁^{m}Fᵢ[l]Sₖ[l]Q[l]T[l] and this discretized equation is then solved for T(λ) based on: T=(FSQ)⁻¹I using the same procedure as described above for solving spectral intensity of the ambient light. In this case, the FSQ matrix is an element-by-element product (i.e., F⊙S⊙Q). The FSQ matrix can be 3 matrices each of size 729×341⊙1×341⊙1×341 for three I(λ) matrices of size 729×1, one for each of the trichromatic channels; or the FSQ matrix can be one matrix of size 2187×341 for one I(λ) matrix of size 2187×1. The T(λ) matrix is of size 341×1. The inverse of the matrix FSQ can be determined by the same optimization process known to a person having ordinary skill in the art.

As discussed above, a similar process can be implemented if the sample is opaque and is juxtaposed next to the trichromatic printed color chart. In this case, the system model takes the form of:

$${I}_{p , q , k} = {\int }_{{λ}_{min}}^{{λ}_{max}} {F}_{i} ( λ ) {S}_{k} ( λ ) Q ( λ ) {G}_{p , q} ( λ ) d λ$$

where I_{p,q,k}(λ) is the trichromatic spectral intensity of each trichromatic channel (e.g., in the R, G, and B channels (k=1, 2, and 3 for R, G, and B, respectively) of the pixel corresponding to opaque sample p and q representing the spatial coordinates of the pixel which is a measurable quantity (these values are again obtained from commercially available software, e.g., ADOBE PHOTOSHOP®),
G_{p,q}(λ) is the reflection spectrum of the pixel p,q of the sample, which is an unknown component that is calculated,
Sₖ(λ) represents the spectral response of the trichromatic imaging device, which is a known quantity from above, and
Q(λ) is the spectral intensity of the ambient light, which is also a known quantity from above. It should be noted that while the trichromatic printed color chart does not enter the above equation, the remaining known components, i.e., Sₖ(λ) and Q(λ) were determined utilizing the spectral color chart and the trichromatic printed said spectral color chart. As before, the first step is to discretize the above equation, as provided below:
I_{i,k}=Σₗ₌₁^{m}Sₖ[l]Qₖ[l]G_{p,q}[l] and this discretized equation is then solved for G_{p,q}(λ) based on: G=(SQ)⁻¹I using the same procedure as described above for solving spectral intensity of the ambient light. In this case, the SQ matrix is an element-by-element product (i.e., S⊙Q). The SQ matrix can be 3 matrices each of size 1×341⊙1×341 for three I(λ) matrices of size 1×1, one for each of the trichromatic channels for each of p,q pixels; or the FSQ matrix can be one matrix of size 3×341 for one I(λ) matrix of size 3×1. The G_{p,q}(λ) matrix is of size 341×1. The inverse of the matrix SQ can be determined by the same optimization process known to a person having ordinary skill in the art.

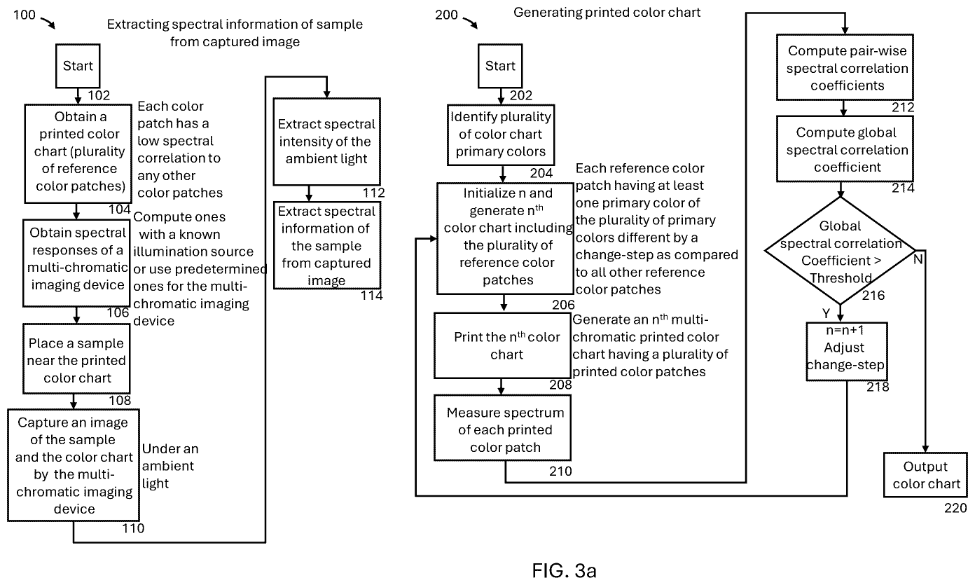

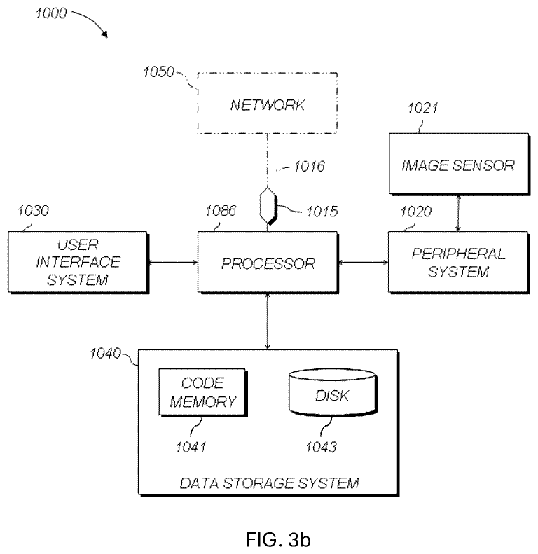

In operation, various steps are performed in order to extract spectral information of a sample that is placed near a color chart, as provided in FIG. 3a. The method 100 begins at block 102, and proceed to block 104 whereby the a user obtain a printed color chart including a plurality of reference color patches. Each color patch has a low spectral correlation to any other color patch in the plurality of reference color patches. Next the method proceeds to block 106 where a user obtain spectral responses of a multi-chromatic imaging device (e.g., camera of a smartphone). This step can be performed in two ways: i) computes ones by acquiring an image with the color chart and a known light source illumination; or ii) use predetermined ones for the particular imaging device. Next the method proceeds to step 108 where the user places a sample near the printed color chart (the sample may be translucent where the sample is placed between an imaging device and the printed color chart, or the sample may be opaque where the sample is placed next to the printed color chart). Next the method proceeds to block 110 where the user captures an image of the sample and the color chart by the multi-chromatic imaging device. This image is captured under an ambient light. Next the method proceeds to block 112 where the user extract spectral intensity of the ambient light. With the extracted spectral intensity of ambient light, the method next proceeds to block 114 where the user extract spectral information of the sample from the captured image.

FIG. 3a also provides steps involved in obtaining the printed color chart used in step 104. The method 200 begins at block 202 and proceeds to block 204 where a plurality of color chart primary colors are identified. Next, the method proceeds to block 206 where an index n is initialized and a n^{th} color chart is generated including a plurality of reference color patches, wherein each reference color patch has at least one primary color of the plurality of primary colors different by a change-step as compared to all other reference color patches. Next the method proceeds to block 208 where the n^{th} color chart is printed using a printer having a plurality of printer primary colors, thereby generating an n^{th} multi-chromatic printed color chart having a plurality of printed color patches. Next the method proceeds to block 210 where spectrum of each printed color patch of the plurality of printed color patches of the n^{th} multi-chromatic printed color chart is measured. Next the method proceeds to block 212 where a plurality of pairwise spectral correlation coefficients are computed for each pair of reference color patches of the n^{th} multi-chromatic printed color chart. Next the method proceeds to block 214 where a global spectral correlation coefficient is computed based on the computed plurality of pairwise spectral correlation coefficients. Next in query 216, the method determiners if the global spectral correlation coefficient is greater than a predetermined threshold. If the answer to the query is yes, then the method proceeds to block 218 where n is increased by 1 and the method adjust the change-step and returns to block 206. If the answer to the query is no, then the method outputs a final color chart as the printed color chart.

Referring to FIG. 3b, an example of a computer system is provided that can carry out the above-described processing steps. Referring to FIG. 3b, a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

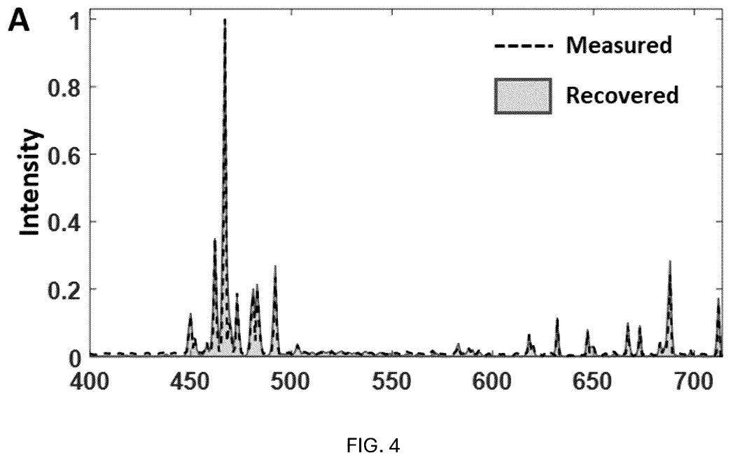

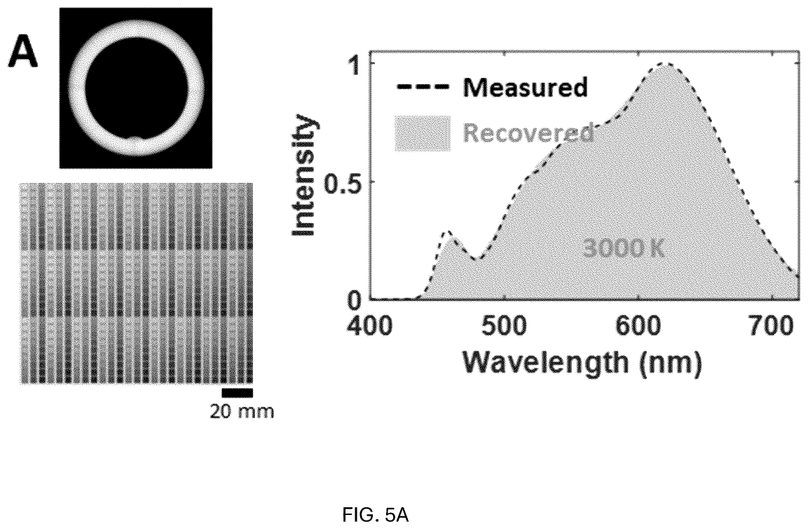

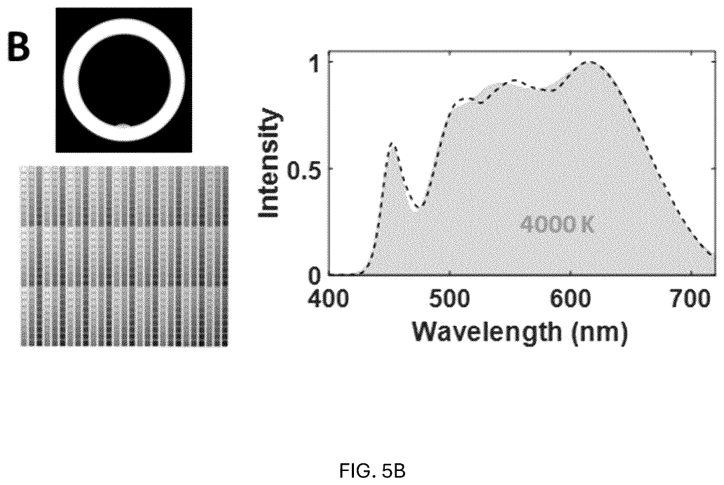

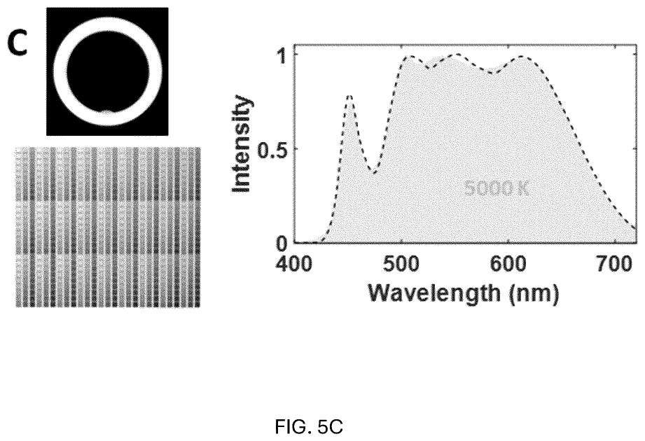

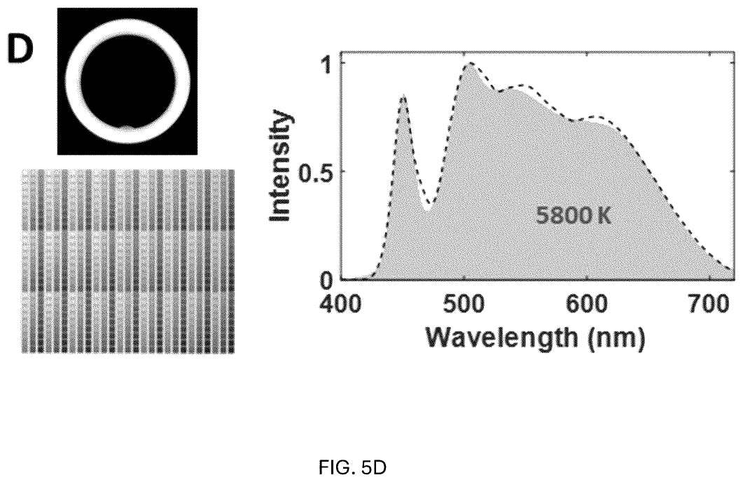

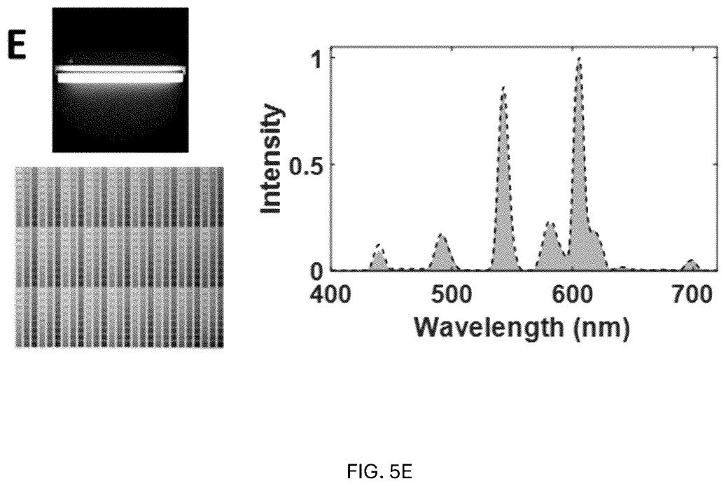

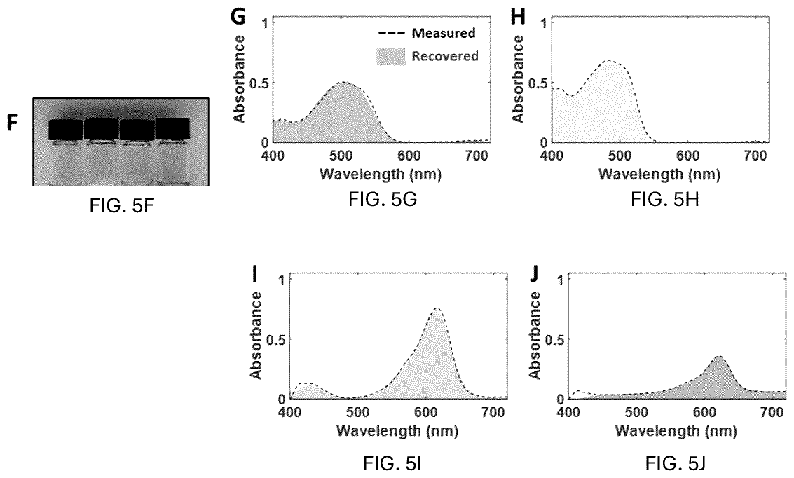

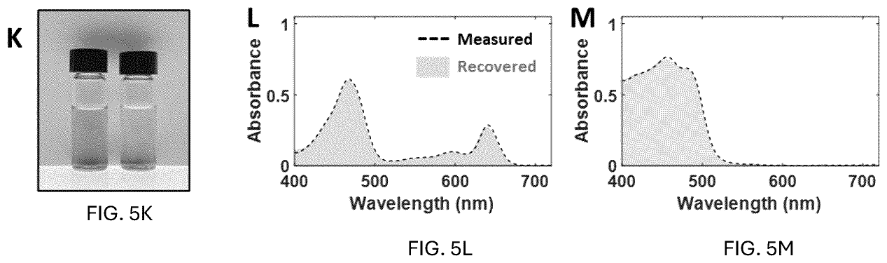

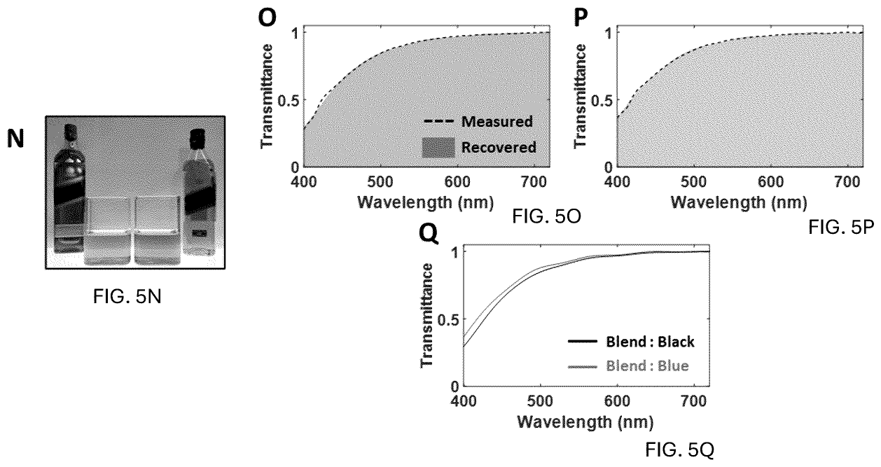

An actual reduction to practice of the system according to the present disclosure was used to determine the efficacy of the described novel approach. Referring to FIG. 4, a spectrum of a Xenon calibration lamp measured using a scientific spectrometer is shown as well as recovered by PCS using an onboard smartphone camera (Samsung Galaxy S21). Referring to FIGS. 5A-5Q, recovered spectral profiles of various light sources and aqueous solutions are provided. In particular, FIG. 5A depicts a ring-shape LED illuminating at a temperature set at 3000 K and spectral color chart (number of reference colors=729) under the corresponding illumination are shown. A measured and recovered spectra are also shown. In FIG. 5B the ring-shape LED is illuminated at 4000 K and corresponding trichromatic printed color chart are shown. The measured and recovered spectra are also shown. In FIG. 5C, the ring-shape LED operating at 5000 K and corresponding trichromatic printed color chart are shown. The measured and recovered spectra are also shown. In FIG. 5D the ring-shape LED operating at 5800 K and corresponding trichromatic printed color chart are shown. The measured and recovered spectra are also shown. In FIG. 5E, a rod-shape fluorescent tube light and corresponding trichromatic printed color chart are shown. The measured and recovered spectra are also shown. In FIG. 5F, a representative photograph of four different food coloring solution samples: Red #40, Yellow #6, Green #1, and Blue #1 is shown. The measured and recovered absorption spectra: are also shown in FIGS. 5G, 5H, 5I, and 5J for food coloring Red #40, Yellow #6, Green #1, and (J) and Blue #1, respectively. In FIG. 5K, a representative photograph of protein solution samples: chlorophyll-b and β-carotene is shown. The measured and recovered absorption spectra are shown in FIGS. 5L, and 5M for chlorophyll-b and (M)β-carotene, respectively. In FIG. 5N, a representative photograph of high-value alcoholic spirits of two different blends is shown. The measured and recovered transmission spectra of one blend and of another blend are shown in FIGS. 5O and 5P. A comparison of the recovered transmission spectra of the two blends, differentiating short wavelength range is shown in FIG. 5Q. These figures show the efficacy of the novel approach of the present disclosure.

Those having ordinary skill in the art will recognize that numerous modifications can be made to the specific implementations described above. The implementations should not be limited to the particular limitations described. Other implementations may be possible.

1. A color chart having a plurality of reference color patches with low spectral correlation, comprising:
a color chart having a plurality of reference color patches, each reference color patch of the plurality of reference color patches having at least one primary color chosen from a plurality of primary colors different by a predetermined change-step as compared to all other reference color patches in the plurality of reference color patches,
wherein pairwise spectral correlation coefficients of all pairs of the plurality of reference color patches result in a computed global correlation coefficient which is less than a predetermined threshold.

2. The color chart of claim 1, wherein reference color of the plurality of reference color patches is determined based on a pseudocode:
```
For p=0,100/(change-step)
  For q=0,100/(change-step)
    For r=0,100/(change-step)
    n=1
    color patchₙ (primary color₁(r*change step), primary color₂(q*change
  step), primary color₃(p*change step))
    n=n+1
    next r
  next q
next p,
```
wherein, the primary colorₘ where m=1, 2, and 3 represent three primary colors.

3. The color chart of claim 1, wherein the change-step is adjusted based on a look-up table.

4. The color chart of claim 1, wherein the change-step is adjusted based on the computed global spectral correlation coefficient.

5. The color chart of claim 1, wherein spectrum of each reference color patch of the plurality of reference color patches is measured using a spectrometer.

6. The color chart of claim 5, wherein each of the measured spectra is between a first wavelength and a second wavelength, wherein the first and second wavelengths are in the visible range.

7. The color chart of claim 1, wherein the global correlation coefficient is computed as an average of the pairwise correlation coefficients of spectra of the reference color patches.

8. A method of extracting spectral information of a sample from a multi-chromatic photograph of the sample, comprising:
obtaining a printed color chart having a plurality of reference color patches where each reference color patch having an associated spectral information with a low spectral correlation to any other reference color patches of the plurality of reference color patches;
obtaining spectral responses of a multi-chromatic imaging device;
placing a sample near the printed color chart;
capturing an image of the sample and the printed color chart by the multi-chromatic imaging device under an arbitrary ambient light;
extracting spectral intensity of the arbitrary ambient light; and
extracting spectral information of the sample from the captured image.

9. The method of claim 8, wherein the printed color chart is generated based on:
a) identifying a plurality of color chart primary colors;
b) initializing n and generating an n^{th} color chart including the plurality of reference color patches, with each reference color patch having at least one primary color of the plurality of primary colors different by a change-step as compared to all other reference color patches in the plurality of reference color patches;
c) printing the n^{th} color chart using a printer having a plurality of printer primary colors, thereby generating an n^{th} multi-chromatic printed color chart having a plurality of printed color patches;
d) measuring spectrum of each printed color patch of the plurality of printed color patches of the n^{th} multi-chromatic printed color chart;
e) computing a plurality of pairwise spectral correlation coefficients for each pair of reference color patches of the n^{th} multi-chromatic printed color chart;
f) computing a global spectral correlation coefficient based on the computed plurality of pairwise spectral correlation coefficients;
g) if the global spectral correlation coefficient is greater than a predetermined threshold, increasing n by 1 and repeating steps b-g by adjusting the change-step; and
h) if the global spectral correlation coefficient is less or equal than the predetermined threshold, outputting a final color chart as the printed color chart.

10. The method of claim 9, wherein color of the plurality of reference color patches is determined based on a pseudocode:
```
For p=0,100/(change-step)
  For q=0,100/(change-step)
    For r=0,100/(change-step)
    n=1
    color patchₙ (primary color₁(r*change-step), primary
    color₂(q*change-
  step), primary color₃(p*change-step))
    n=n+1
    next r
  next q
next p
```
wherein, the primary colorₘ where m=1, 2, and 3 represent three primary colors.

11. The method of claim 9, wherein the step of adjusting the color change step is based on a look-up table.

12. The method of claim 9, wherein the step of adjusting the color change step is based on the computed global spectral correlation coefficient.

13. The method of claim 9, wherein each of the measured spectra is between a first wavelength and a second wavelength, wherein the first and second wavelengths are in the visible range.

14. The method of claim 8, wherein the step of obtaining spectral responses of the multi-chromatic imaging device includes:
capturing or using a pre-captured photograph of the printed color chart under a known ambient light by the multi-chromatic imaging device;
analyzing the captured photograph to thereby obtain intensity levels of each channel of the multi-chromatic imaging device for each of the plurality of reference color patches;
construct a model based on known quantities including i) the obtained intensity levels, ii) spectral information of the known ambient light, iii) spectral information of each reference color patch, and iv) unknown quantities of spectral responses of the multi-chromatic imaging device; and
solve for the unknown quantities of spectral response of the multi-chromatic imaging device.

15. The method of claim 8, wherein the step of extracting spectral intensity of the arbitrary ambient light includes:
capturing a photograph of the printed color chart under the arbitrary ambient light by the multi-chromatic imaging device with known spectral response for each channel thereof;
analyzing the captured photograph to thereby obtain intensity levels of each channel of the multi-chromatic imaging device for each of the plurality of reference color patches;
construct a model based on known quantities including i) the obtained intensity levels, ii) spectral information of each reference color patch, iii) spectral response of the multi-chromatic imaging device, and iv) unknown quantities of spectral intensity of the arbitrary ambient light; and
solve for the unknown quantities of spectral intensity of the arbitrary ambient light.

16. The method of claim 8, wherein the step of extracting spectral information of the sample from the captured image of the sample includes:
capturing a photograph of the printed color chart under the arbitrary ambient light with known spectral intensity by the multi-chromatic imaging device with known spectral response for each channel thereof;
analyzing the captured photograph to thereby obtain intensity levels of each channel of the multi-chromatic imaging device for each of the plurality of reference color patches;
construct a model based on known quantities including i) the obtained intensity levels, ii) spectral information of each reference color patch, iii) spectral response of the multi-chromatic imaging device, iv) spectral intensity of the arbitrary ambient light, and v) unknown quantities of spectral intensity of the sample; and
solve for the unknown quantities of spectral intensity of the sample from the captured image.

17. The method of claim 16, wherein the sample is translucent and the sample is placed between the printed color chart and the multi-chromatic imaging device when the image of the sample is captured.

18. The method of claim 8, wherein the step of extracting spectral information from the captured image of the sample includes:
analyzing the captured photograph of the sample to thereby obtain intensity levels of each channel of the multi-chromatic imaging device for each pixel of the captured image;
construct a model based on known quantities including i) the obtained intensity levels, ii) spectral response of the multi-chromatic imaging device, iii) spectral intensity of the arbitrary ambient light, and iv) unknown quantities of spectral information of the sample from the captured image of the sample; and
solve for the unknown quantities of spectral information of the sample from the captured image of the sample, wherein the sample is opaque and the sample is placed between the printed color chart and the multi-chromatic imaging device when the image of the sample is captured.

19. The method of claim 9, wherein the global correlation coefficient is computed as an average of the pairwise correlation coefficients of the spectra of the reference color patches.

20. The method of claim 9, wherein the plurality of reference color patches include 729 reference color patches based on the change-step of 12.5.
